(19) United States
(12) Patent Application Publication
(10) Pub. No.: US 2004/0024131 A1
(43) Pub. Date: Feb. 5, 2004

(54) Melt-processable amino resin based on 1,3,5-triazines and aldehydes

(76) Inventors: Frank Borner, Von-der-Trenck Strasse (DE); Gerald Rafler, Potsdam (DE); Eckhard Bonatz, Teltow (DE)

Correspondence Address: EDWARDS & ANGELL, LLP, P.O. BOX 9169, BOSTON, MA, 02209, US

(21) Appl. No.: 10/416,861

(22) PCT Filed: Nov. 5, 2001
(86) PCT No.: PCT/EP01/12789

(30) Foreign Application Priority Data
Nov. 14, 2000 (DE) 100 56 398.8

(51) Int. Cl. C08G 12/00

(52) U.S. Cl. 525/254

(57) ABSTRACT

Etherified 2,4-diamino-1,3,5-triazine-aldehyde resins are described, which, in contrast to conventional resins of this type, have softening points above 100° C. and can be melt-processed at from 100 to 200° C., in particular at from 130 to 150° C., without curing. The resins according to the invention can be processed by thermoplastic shaping methods both to form fibres or films and to form mouldings. They can furthermore be processed in powder or granule form, since they do not adhere at room temperature. These resins are cured by acidic additives and/or temperatures above 240° C.

The invention relates to an etherified amino resin based on 1,3,5-triazines and aldehydes (referred to below as amino resin) which has a softening point above 100° C., and to its further thermoplastic-like processing to form fibres, films, workpieces or its use in thermoplastically processable coating systems.

### BACKGROUND OF THE INVENTION

Melamine-based amino resins are versatile network polymers having a high Young's modulus. They undergo only minor shrinkage when curing. Although the cured materials are mechanically very stable, they are also very brittle owing to their chemical structure.

The cured amino resins are unmeltable, and they are therefore used in the form of soluble prepolymers of low molecular weight, which are cured to form network polymers after shaping. This form of processing leads to their preferred use for the production of composite materials and in coating systems. Typical applications are found in laminate production, paper coating, encapsulation of liquids and solids, or in combination with alkyd resins for high-quality paint/varnish systems.

Whereas methyl-etherified amino resins are normally used as liquids during processing, unetherified products can also be processed as dry powders after addition of solvent.

Conventional melamine-formaldehyde solid resins are unetherified and become tacky by absorbing moisture. Unetherified melamine-formaldehyde resins react even at room temperature.

Besides the large-scale uses of melamine-formaldehyde materials, special applications of these amino resins are also known, for example in the production of fibres for flame-retardant textiles in the field of protective clothing. For instance, DE-A 2 364 091 describes a process for producing melamine resin fibres, in which an aqueous solution is forced through a nozzle in a hot air stream and cured by drying. Owing to the production process, these fibres have diameter and fibre-length distributions which limit their use (H. Berber, Chemiefasern 37 (1994), T125-T127).

The melamine resin fibre BASOFILTM produced commercially for fire protection clothing is obtained according to U.S. Pat. No. 5,084,488 by a centrifugal spinning process.

Amino resin granules made of base materials such as paper stock and wood flour are furthermore known (JP-A2-56030433).

It is furthermore known that etherified melamine-formaldehyde precondensates can be cured at room temperature or moderately elevated temperature in the presence of acidic catalysts to form a nonmeltable network polymer. After partial hydrolysis of the methoxy groups, the methylols which are formed condense to form the crosslinked polymers. When curing, a gel phase is initially formed under standard conditions. Some of the products crosslink in this gel phase. The degree of crosslinking produced in this way determines the resin properties. In the art, these cured resins are used as additives for melamine resins, in order to reduce the mass loss which occurs during condensation, and therefore to keep the shrinkage low.

### DESCRIPTION OF THE INVENTION

It is an object of the invention to provide an amino resin which does not cure in the melt, and which can be converted by melting into any fibre, flat or three-dimensional form which is cured after shaping. This object is achieved according to the invention by etherified amino resins, which can be obtained by:

(a) Reacting a 2,4-diamino-1,3,5-triazine or a mixture of 2,4diamino-1,3,5-triazines of the following general Formula (I)

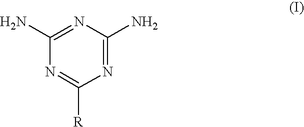

in which R stands for NH₂, OH, C₁ to C₁₂ alkyl or substituted or unsubstituted phenyl, with an aldehyde which contains from 1 to 12 carbon atoms and one or more aldehyde groups, in order to obtain an unetherified amino resin, and

(b) Reacting the unetherified amino resin obtained in stage (a) with an alcohol having from 1 to 12 carbon atoms and

(c) Precuring the etherified amino resin obtained in stage (b) at temperatures of from 160 to 200° C.

In the aforementioned Formula (I), the residue R may stand for NH₂, OH, an alkyl group having from 1 to 12 carbon atoms or a substituted or unsubstituted phenyl group. Suitable substituents for the phenyl group are alkyl, alkoxy groups and halogens.

In the scope of the present invention, an alkyl group means a straight-chained or branched hydrocarbon residue having from 1 to 12, preferably from 1 to 5, carbon atoms.

By alkoxy groups are intended residues of the general formula OCₙH₂ₙ₊₁, in which n stands for a natural number of from 1 to 12, preferably from 1 to 5.

Suitable halogens are fluorine, chlorine, bromine and iodine.

When carrying out stage (a) described above, a 1,3,5-triazine of Formula (I) or a mixture of 1,3,5-triazines corresponding to this formula are reacted with one or more aldehydes at a temperature in the range of 20-100° C., and preferably 40-70° C. The aldehyde which is used comprises from 1 to 12 carbon atoms and up to 3 CHO groups. Preferred aldehydes are formaldehyde, glutaraldehyde and glyoxal.

The substance quantity ratio of triazine to aldehyde is in this case generally from 1:1 to 1:3, and preferably 1:2. Some products of stage (a) are commercially available and are sold, for example, under the brand name Lamelite™.

The unetherified amino resin obtained according to stage (a) is reacted in stage (b) with an alcohol having from 1 to 12 carbon atoms, preferably from 1 to 5, more particularly preferably from 1 to 3 carbon atoms. The reaction is carried out at a temperature of 10-60° C., and preferably 20-40° C.

The weight ratio of alcohol to unetherified amino resin is generally 5:1, and preferably 2:1. Methanol, ethanol and propanol are preferably used as the alcohols.

A catalyst is expediently used in this case. Strong inorganic acids, in particular hydrochloric acid, are suitable as the catalyst.

According to a preferred embodiment, an unetherified amino resin is used in stage (b), the NH groups of which have been modified with one or more substances selected from the group consisting of urea, guanidine, guanidinium salts, saturated and unsaturated amides. This modification may be carried out directly during the synthesis of the unetherified amino resin by adding the modification component to the triazine/aldehyde reaction mixture, or in a separate synthesis step, the actual co-condensation then taking place during and after the etherification. Suitable guanidinium salts are, for example, guanidinium halides or sulfate.

The amides furthermore used as modifiers are phenyl amides, saturated and unsaturated alkyl amides and preferably maleic diamide, acrylamide and acetamide.

The amino resin obtained after etherification is subsequently treated further at temperatures of from 160 to 200° C., preferably from 160 to 180° C. (“precuring”). The precuring expediently takes place in equipment having a high mixing intensity and/or a high evaporation capacity. Examples are single- or double-screw extruders, mixers or thin-film evaporators. Extruders and thin-film evaporators are particularly preferred. Such devices are known per se to the person skilled in the art and are described, for example, in Ch. Rauwendaal: “Polymer Extrusion”, Carl Hanser Verlag (1994).

The residence time, i.e. the duration of the precuring, is generally from 1 to 30 min, and preferably from 5 to 10 min.

This precuring provides a resin which is not longer tacky and has a softening point above 100° C. More than 90%, preferably more than 95%, of the methylol groups are removed or cleaved by the precuring, so that these are no longer detectable by means of NMR spectroscopy.

The resin is not set by the precuring, i.e. it remains meltable and soluble.

The amino resin according to the invention is expediently stabilised by various measures. According to one embodiment, the stabilisation of the resin takes place by adjusting the pH from 6.5 to 9, in particular from 7 to 8. This adjustment of the pH is carried out by adding a solution of a base in methanol (e.g. sodium hydroxide or potassium hydroxide) to the reaction mixture after the etherification and before the precuring. In order to determine the pH, after having added the aforementioned components, a pH paper is wetted and covered with a film of water.

A further measure which serves to stabilise the resin is desalification in alcohols, in particular in butanol, with subsequent filtration of the alcoholic amino resin/salt mixture. This involves adding the alcohol to the resin and mixing them, then waiting until insoluble salts have precipitated. These salts are then removed by filtration.

According to a preferred embodiment, the purification used for stabilisation takes place by melt filtration at a temperature of from 100 to 200° C., preferably 140° C. Melt filtration is known per se to the person skilled in the art.

The precured amino resins according to the invention can be cured in the presence of acidic gases, liquids or solids and/or at temperatures above 240° C. to form insoluble and unmeltable products. The resins according to the invention can, in particular, be used for producing fibrids, fibres, films, multilayer films or mouldings.

A multilayer film produced by using the precured amino resin according to the invention can, in particular, be used to form a fire-retardant, nonmeltable coating, by applying the multilayer film onto a substrate and fusing it. Such a coating can also be formed by powdering or granulating the precured resin according to the invention, applying it onto a substrate as a powder or granules and fusing it.

The precured, etherified amino resins according to the invention have a range of material-scientific and processing-technological advantages, which will be described below.

They are mechanically stable, readily handlable and, owing to a low network density, fully soluble in dimethyl sulfoxide (DMSO) and can therefore be analysed from solution particularly reliably before the further processing.

In particular when the pH is kept between 7 and 9, these resins are thermally very stable and they can also be readily formed into fibres, films or mouldings at elevated temperatures of from 130° C. to 150° C.

In contrast to the known processes for producing melamine resin fibres (DE-A 2 364 091, U.S. Pat. No. 5 084 488), in which operation is carried out from aqueous solutions, fibres can be spun from the melt with the amino resins produced according to the invention without using fibre-forming auxiliary polymers. The triazine resin fibres are not precured during the processing, but rather are first acidically precured at the fibre surface after shaping and then thermally post-cured throughout their volume. The fibres produced by melt spinning in the described way are characterised by a uniform diameters, and it is possible to spin endless fibres.

The elasticity of the triazine products according to the invention can be deliberately modified by adding benzoguanamine resins or ammeline resins.

The curing of the resins according to the invention is accompanied by only a relatively minor mass loss, so that besides spinning, these resins are also suitable for processing by means of further thermoplastic shaping methods, such as profile extrusion or thermopressing, optionally with the addition of particulate additives in quantities of up to 60% by mass.

Owing to the fact that the resins according to the invention do not adhere, they can be converted both into powder form and into granules.

### EXAMPLES

The invention will be explained in more detail below by the following examples:

### Example 1

### (Production of a Resin According to the Invention)

(1) Etherification of a Melamine-Formaldehyde Solid Resin:

200 ml of conc. HCl (37%) are added to 9 l of methanol at 33.6° C. 3 kg of a trimethylol melamine (condensation product of 1 part melamine and 2 parts of a 36% strength aqueous formaldehyde solution) are then added within 30 min. The temperature rises to 35.6° C. during this. 30 min after addition, the reactor temperature was again 33.6° C. After a further 50 min, neutralisation is carried out with KOH in methanol (pH 8-9) and about 7 l of methanol are distilled off at 250 mbar (60° C. jacket temperature). After adding 2 l of butanol, 2 h are waited until the salts have settled, then after filtration through a cloth, the resin is re-concentrated until it has a viscosity of about 500 poise at 30° C.

(2) Precuring in the Extruder:

The resin obtained in stage (1) is both dried and precured in a co-rotating double-screw extruder at a temperature of between 160 and 185° C. The residence time in the extruder lies in an interval of from 5 to 15 min. Unreacted methylol groups are in this case cleaved off in the form of formaldehyde. The softening point of the resin precured in this way is about 100° C. This resin becomes fluid at about 140° C.

A sample of the resin dissolved in dimethyl sulfoxide-d₆ is analysed by ¹³C NMR spectroscopy. No methylol groups are detectable any longer in the spectrum.

### Example 2

### (Conversion into Granule Form)

The resin from Example 1 is melted at 145° C. in the extruder and subsequently obtained through a die as an extrudate, which is converted into granule form by a granulator.

### Example 3

### (Forming into a Melamine Resin Fibre)

5 g of resin from Example 1 are melted at 145° C. and forced slowly through a cannula by an injection doser. The first drop falls onto a spinning wheel and is drawn uniformly over about 2 h. After shaping, the thread is initially stored for 14 h over traces of HCl at room temperature, before being heat-treated for 2 h at 180° C. in a vacuum. The threads had a yellowish colouration.

Material properties:

| Young's modulus | 500-550 cN/tex |
|---|---|
| Tensile strength | 5-10 cN/tex |
| Extension | 1.3-2.0% |

### Example 4

### (Production of a Benzoguanamine-Modified Melamine Resin Fibre)

(1) Production of a Benzoguanamine-Formaldehyde Resin:

50 g (0.267 mol) of benzoguanamine are heated in 107 g (1.1 mol) of 30% strength formaldehyde for about 3 h, until the guanamine has dissolved clearly. 500 ml of methanol and 2 ml of conc. HCl are then added at room temperature. After 1 h, neutralisation is carried out with KOH (dissolved in methanol) and the solvent is evaporated.

(2) Production of a Benzoguanamine-Modified Melamine Fibre

4 g of the resin from Example 1 are mixed with 1 g of the guanamine resin produced in (1), melted at 145° C. and forced slowly through a cannula by an injection doser in a similar way to Example 4. The first drop falls onto a spinning wheel and is drawn uniformly over about 2 h. After shaping, the thread is initially stored for 12 h over traces of HCl at room temperature, before being heat-treated for 2 h at 180° C in a vacuum.

Material properties:

| Yopung's modulus | 480-540 cN/tex |
|---|---|
| Tensile strength | 9-15 cN/tex |
| Tensile strength | 1.7-2.2% |

1. Etherified 2,4-diamino-1,3,5-triazine-aldehyde resin obtainable by:
(a) Reacting a 2,4-diamino-1,3,5-triazine or a mixture of 2,4diamino-1,3,5-triazines of the following general Formula (I) 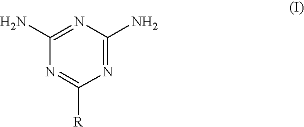
in which R stands for NH₂, OH, C₁ to C₁₂ alkyl or substituted or unsubstituted phenyl, with an aldehyde which contains from 1 to 12 carbon atoms and one or more aldehyde groups, in order to obtain an unetherified 2,4-diamino-1,3,5-triazine-aldehyde resin, and
(b) reacting the 2,4-diamino-1,3,5-triazine-aldehyde resin obtained in stage (a) with an alcohol having from 1 to 12 carbon atoms and
(c) precuring the 2,4-diamino-1,3,5-triazine-aldehyde resin obtained in stage (b) at temperatures of from 160 to 200° C.

2. 2,4-Diamino-1,3,5-triazine-aldehyde resin according to claim 1, characterised in that an unetherified 2,4-diamino-1,3,5-triazinealdehyde resin was used in stage (b), the NH groups of which were modified with one or more substances selected from the group consisting of urea, guanidine, guanidinium salts, amides of saturated and unsaturated carboxylic acids having from 1 to 5 carbon atoms.

3. 2,4-Diamino-1,3,5-triazine-aldehyde resin according to one of claims 1 and 2, characterised in that the aldehyde used in stage (a) is formaldehyde, glutaraldehyde or glyoxal.

4. 2,4-Diamino-1,3,5-triazine-aldehyde resin according to one of claims 1 to 3, characterised in that it has been stabilised by adjusting the pH to from 6.5 to 9, in particular from 7 to 8.

5. 2,4-Diamino-1,3,5-triazine-aldehyde resin according to one of claims 1 to 4, characterised in that it has been stabilised by desalification in alcohols, in particular n-butanol, and subsequent filtration.

6. 2,4-Diamino-1,3,5-triazine-aldehyde resin according to one of claims 1 to 5, characterised in that it has been purified by melt filtration at from 100 to 200° C.

7. Process for producing etherified 2,4-diamino-1,3,5-triazinealdehyde resins according to claim 1, comprising the following stages:
(a) Reacting a 2,4-diamino-1,3,5-triazine or a mixture of 2,4diamino-1,3,5-triazines of the following general Formula (I) 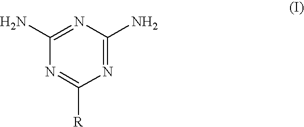
in which R stands for NH₂, OH, C₁ to C₁₂ alkyl or substituted or unsubstituted phenyl, with an aldehyde which contains from 1 to 12 carbon atoms and one or more aldehyde groups, in order to obtain an unetherified 2,4-diamino-1,3,5-triazine-aldehyde resin, and
(b) Reacting the 2,4-diamino-1,3,5-triazine-aldehyde resin obtained in stage (a) with an alcohol having from 1 to 12 carbon atoms and
(c) Precuring the 2,4-diamino-1,3,5-triazine-aldehyde resin obtained in stage (b) at temperatures of from 160 to 200° C.

8. Process according to claim 7, characterised in that the precuring is carried out in equipment having a high mixing intensity and/or a high evaporation capacity.

9. Process according to claim 8, characterised in that single- or double-screw extruders, mixers or thin-film evaporators are used as the equipment having a high mixing intensity and/or a high evaporation capacity.

10. Process for curing a 2,4-diamino-1,3,5-triazine-aldehyde resin according to one of claims 1 to 6, characterised in that the resin is cured in the presence of acidic gases, liquids or solids and/or at temperatures above 240° C. to form an insoluble and unmeltable product.

11. Use of an etherified 2,4-diamino-1,3,5-triazine-aldehyde resin according to one of claims 1 to 6 for producing fibrids, fibres, films, in particular multilayer films or mouldings.

12. Use of a multilayer film obtained by the use according to claim 11 for forming a fire-retardant, nonmeltable coating, characterised in that the multilayer film is applied onto a substrate and fused.

13. Use of an etherified 2,4-diamino-1,3,5-triazine-aldehyde resin according to one of claims 1 to 6 for producing fire-retardant, nonmeltable layers, characterised in that the resin is powdered, applied onto a substrate and fused.
